(19) United States
(12) Patent Application Publication
(10) Pub. No.: US 2010/0187811 A1
(43) Pub. Date: Jul. 29, 2010

(54) ROTATABLE COUPLING

(76) Inventors: Alan Topping, Derbyshire (GB); Steven Smith, Wednesbury (GB)

Correspondence Address: The Ollila Law Group LLC, 2569 Park Lane, SUITE 202, Lafayette, CO, 80026, US

(21) Appl. No.: 12/678,209

(22) PCT Filed: Sep. 24, 2007
(86) PCT No.: PCT/GB07/03612

§ 371 Date: Mar. 15, 2010

(51) Int. Cl. F16L 27/08

(52) U.S. Cl. 285/148.4

(57) ABSTRACT

A rotatable coupling (50) includes a body (55) and a retaining member (70). The body defines a cavity (51). The cavity extends from a. first end (56) of the body (55) to a second end of the body (57). The second end (57) of the body (55) includes an outer surface (68). The outer surface (68) on the second end (57) of the body (55) defines a retaining groove (57). The retaining member (70) is rotatably mounted within the retaining groove (57) and provided with a plurality of raised flexible teeth (71).

### FIELD OF THE INVENTION

The present invention relates to a rotatable coupling, and, particularly, in an embodiment, to a rotatable coupling that functions as a pressurized component.

### BACKGROUND OF THE INVENTION

Rotatable couplings are common in many applications. For example, in pressurized systems, such as pneumatic or hydraulic systems, often times a rotatable coupling will be used as an interface between two different components where it is desirable to impart relative rotation between the two components. Such rotatable couplings are typically fabricated from two pieces that each connect to one of the components. In order to impart relative rotation between the two components, the two pieces of the rotatable coupling are usually rotatably connected to each other. The foregoing rotational arrangement often times requires close tolerances between the two pieces and also the use of one or more seals, such as an elastomeric seal, in order to prevent leakage of the pressurized substance at the joint between the two pieces. Furthermore, the close tolerance requirements favor using certain materials, such as brass, to fabricate one or both pieces, where more economical materials could otherwise be used.

The present invention is directed to overcoming these and other disadvantages inherent in the art.

### SUMMARY OF THE INVENTION

The scope of the present invention is defined solely by the appended claims, and is not affected to any degree by the statements within this summary.

In one embodiment of the present invention, a rotatable coupling comprises a body and a retaining member. The body defines a cavity that extends from a first end of the body to a second end of the body. The second end of the body includes an outer surface that defines a retaining groove. The retaining member is rotatably mounted within the retaining groove and provided with a plurality of raised flexible teeth.

In another embodiment of the present invention, a rotatable coupling comprises a body and a retaining member. The body defines a cavity that extends from a first end of the body to a second end of the body. The second end of the body includes an outer surface that defines a retaining groove. The retaining member is rotatably mounted within the retaining groove, provided with a plurality of raised flexible teeth, and provided with a first radial end, a second radial end, and a cutout space that is defined between the first and second radial ends and positioned within the retaining groove.

### Aspects

According to one aspect of the present invention, a rotatable coupling comprises:
a body defining a cavity that extends from a first end of the body to a second end of the body;
the second end of the body includes an outer surface that defines a retaining groove; and
a retaining member that is rotatably mounted within the retaining groove and provided with a plurality of raised flexible teeth.

Preferably, the retaining groove is generally annular in shape.

Preferably, the retaining member is generally annular in shape.

Preferably, the teeth are located at an inner axial end of the retaining member.

Preferably, another groove is located on retaining member outer surface and an elastomeric seal is located within the another groove.

Preferably, another groove is located on the retaining member outer surface, an elastomeric seal is located within the another groove, and the retaining groove is located inward on the second end relative to the another groove.

Preferably, the body is provided with an elbow shape.

Preferably, the body is fabricated as one-piece.

Preferably, the retaining member (70) is provided with a first radial end (103), a second radial end (104), and a cutout (105) located between the first and second radial ends (103, 104).

Preferably, the retaining member is provided with a portion (72), which lies substantially flush with the outer surface (68) on the second end (66) of the body (55).

According to another aspect of the present invention, a rotatable coupling comprises:
a body defining a cavity that extends from a first end of the body to a second end of the body;
the second end of the body includes an outer surface that defines a retaining groove;
a retaining member, wherein the retaining member is:
   rotatably mounted within the retaining groove;
   provided with a plurality of raised flexible teeth; and
   provided with a first radial end, a second radial end, and a cutout space that is defined between the first and second radial ends and positioned within the retaining groove.

Preferably, the retaining groove is generally annular in shape.

Preferably, the retaining member is generally annular in shape.

Preferably, the teeth are located at an inner axial end of the retaining member.

Preferably, another groove is located on retaining member outer surface and an elastomeric seal is located within the another groove.

Preferably, another groove is located on the retaining member outer surface, an elastomeric seal is located within the another groove, and the retaining groove is located inward on the second end relative to the another groove.

Preferably, the body is provided with an elbow shape.

Preferably, the body is fabricated as one-piece.

Preferably, the retaining member (70) is provided with a first radial end (103), a second radial end (104), and a cutout (105) located between the first and second radial ends (103, 104).

Preferably, the retaining member is provided with a portion (72), which lies substantially flush with the outer surface (68) on the second end (66) of the body (55).

### BRIEF DESCRIPTION OF THE DRAWINGS

FIG. 1 depicts a sectional view of a rotatable coupling.

FIG. 2 depicts a sectional view of a rotatable coupling of an embodiment and a port.

FIG. 3 depicts a perspective view of a rotatable coupling of an embodiment.

FIG. 4 depicts a perspective view of a rotatable coupling of an embodiment.

### DETAILED DESCRIPTION OF THE INVENTION

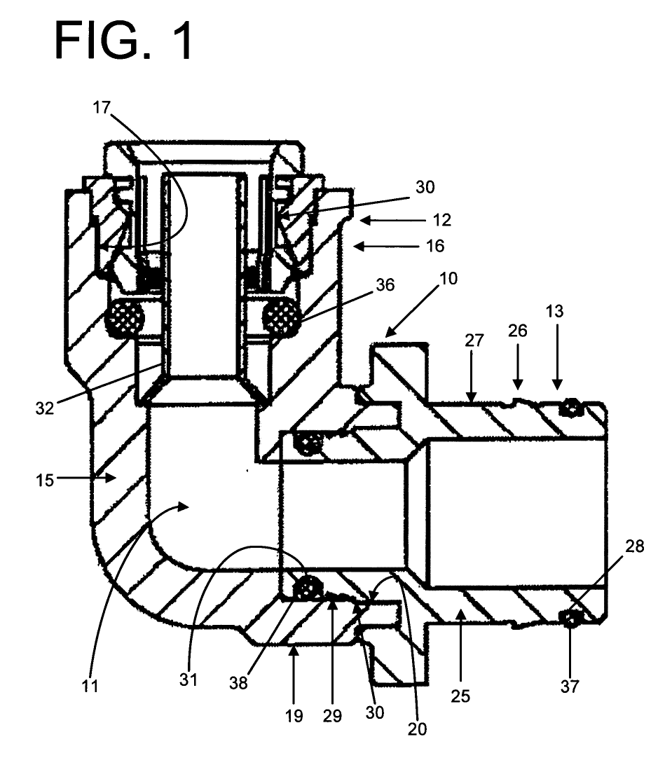

FIG. 1 depicts a rotatable coupling 10 provided in the shape of an elbow. In alternative embodiments, however, the rotatable coupling 10 may be provided with other shapes, including, but not limited to, a “T”, “Y”, or “F” shape. The rotatable coupling 10 defines a cavity 11 that extends from a first end 12 to a second end 13 of the rotatable coupling 10.

As shown, the rotatable coupling 10 is a two-piece coupling that is provided with a first coupling portion 15 and a second coupling portion 25. The first coupling portion 15 is fabricated from plastic and the second coupling portion 25 is fabricated from brass.

The first coupling portion 15 is configured to receive a fitting 30 and an elastomeric seal 36, which may be a gasket, such as an O-ring. As shown, the first coupling portion 15 includes an outer end 16 that defines a receiving surface 17 for receiving the fitting 30. The fitting 30 is located around a funnel 32 positioned within the receiving surface 17. The fitting 30 allows another structure (not shown), such as a hose or another fitting, to be connected to the outer end 16 of the coupling 10 so that pneumatic pressure may be delivered to the structure.

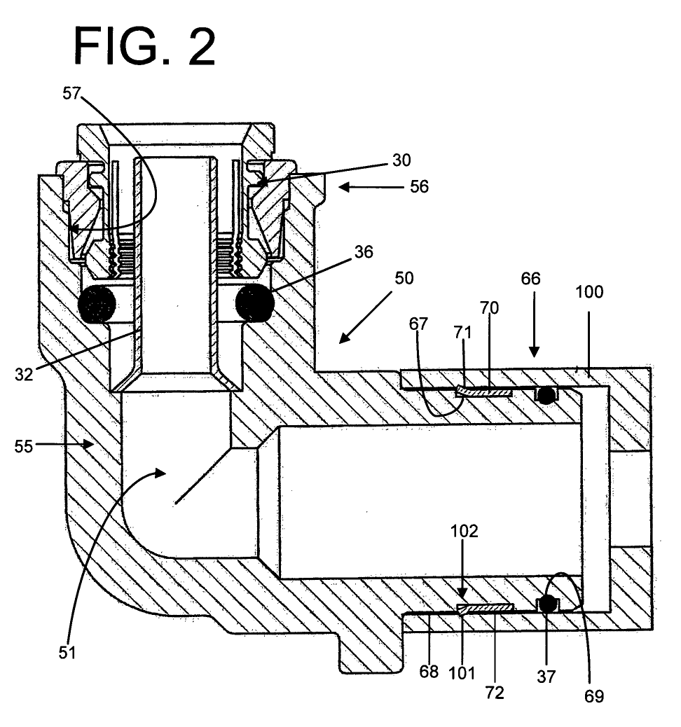

The second coupling portion 25 is configured to connect to a port, such as the port 100 shown in FIG. 2. The second coupling portion 25 is connected to the port by press fitting the outer surface 27 on outer end 26 of the second coupling portion 25 within the port. The outer surface 27 defines a groove 28 for receiving an elastomeric seal 37, which may be a gasket, such as an O-ring, that seals the joint between the second coupling portion 25 and the port.

In order to impart rotation to the rotatable coupling 10, the first and second coupling portions 15, 25 are rotatably connected to each other. As shown, the first and second coupling portions 15, 25 are provided with respective inner ends 19, 29. The inner end 19 of the first coupling portion 15 defines a generally cylindrical receiving surface 20 for receiving a generally cylindrical outer surface 30 of the inner end 29 on the second coupling portion 25. Since the receiving surface 20 on outer surface 30 are generally cylindrical the first portion 15 is able to rotate relative to the second portion 25. As shown, the outer surface 30 defines a groove 31 for receiving an elastomeric seal 38, which may be a gasket, such as an O-ring, that seals the joint between the first and second coupling portions 15, 25.

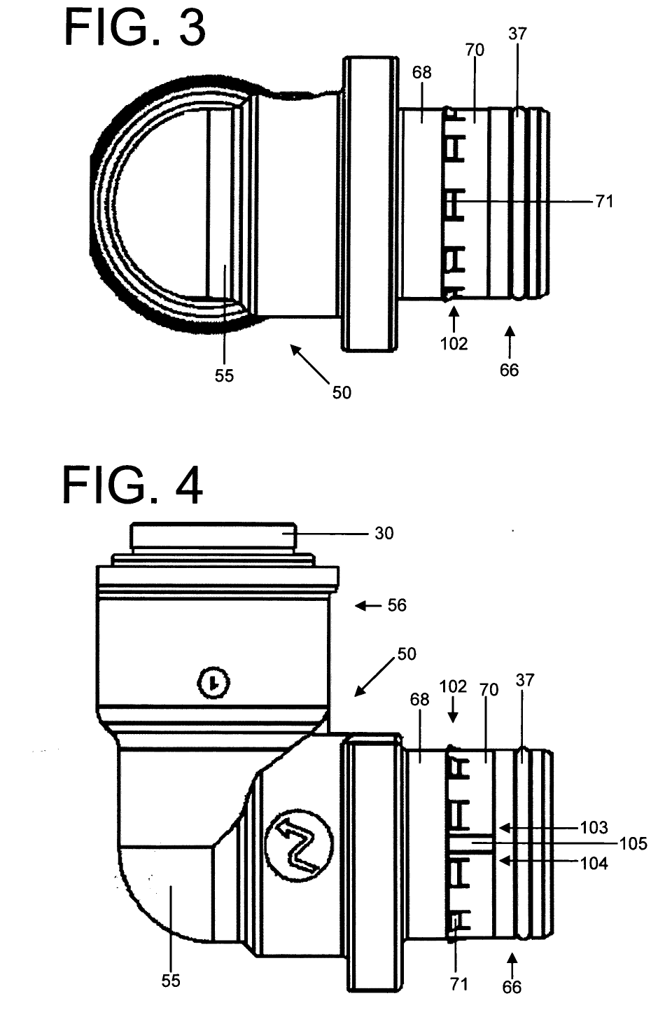

Turning now to FIGS. 2-5, a rotatable coupling 50 of an embodiment is depicted. As shown, the rotatable coupling 50 is provided in the shape of an elbow; however, it is within the scope of the present invention to provide the rotatable coupling with other shapes, such as, for example, and not limitation, a generally cylindrical shape. Also shown, the rotatable coupling 50 defines a cavity 51 that extends from a first end 56 to a second end 66 of the rotatable coupling 50.

As shown, the rotatable coupling 50 of an embodiment includes a one piece body 55, which is preferably fabricated from plastic. Although the body 55 is preferably fabricated from plastic it is within the scope of the present invention to fabricate the body 55 from other materials, such as, for example, and not limitation, a metal material.

In an embodiment, the body 55 is configured to receive a fitting 30 and an elastomeric seal 36, which may be a gasket, such as an O-ring. As shown, the body 55 includes a first end 56 that defines a receiving surface 57 for receiving the fitting 30. The fitting 30 is located around a funnel 32 positioned within the receiving surface 57. The fitting 30 allows another structure (not shown), such as a hose or another fitting, to be connected to the first end 56 of the body 55 so that pneumatic pressure may be delivered to the structure. Those skilled in the art will appreciate that it is within the scope of the present invention for the first end 56 to connect to another structure via arrangements which do not include the fitting 30 and elastomeric seal 36, which may be a gasket, such as an O-ring.

The body 55 is configured to connect to a port, such as the port 100 shown in FIG. 2. In an embodiment, the body 55 is connected to a port via a snap fit. As shown in FIG. 2, located on the second end 66 is a retaining member 70. The retaining member 70 is located within a generally annular retaining groove 67 provided on the outer surface 68 of a second end 66. As shown in FIG. 2, the retaining member 70 is preferably provided with a generally annular shape and includes a plurality of raised flexible teeth 71 and, preferably, a portion 72, which lies substantially flush with the outer surface 68. As shown, the teeth 71 preferably extend away from and protrude outward from the outer surface 68 on the second end 66. In the embodiment depicted, the teeth 71 are shown preferably located at an inner axial end 102 of the retaining member 70; however, it is within the scope of the present invention to position the teeth 71 at other locations on the retaining member 70.

Advantageously, the teeth 71 snap fit under a retaining surface 101 on the port 100 to secure the rotatable coupling 50 to the port 100. However, since the retaining member 70 is rotatably mounted within the retaining groove 67, the rotatable coupling 50 is able to rotate relative to the port 100 when secured to the port 100. Accordingly, the present embodiment can be fabricated from one piece, as opposed to the two pieces as in the design shown in FIG. 1. Furthermore, the sealed interface, including the elastomeric seal 38, which may be a gasket, such as an O-ring, between the inner ends 19 and 20 in the two piece design shown in FIG. 1 may be eliminated. Additionally, the body 55 may be fabricated more economically since the close tolerances in the joint between the first and second coupling portions 15, 25 in the design shown in FIG. 1 are no longer required.

As shown in FIG. 2, the outer surface 68 of the second end 66 preferably defines a groove 69 for receiving an elastomeric seal 37, which may be a gasket, such as an O-ring, that seals the joint between the second end 66 and the port 100. As shown, the retaining groove 67 is preferably located inward on the second end 66 relative to the groove 69.

Turning now to FIG. 4, as shown, the retaining member 70 is preferably provided with a first radial end 103 and a second radial end 104. Located between the radial ends 103, 104 is preferably a cutout 105. Advantageously, the cutout 105 is configured to easily allow the retaining member 70 to be slipped over the second end 66 until it snaps into the retaining groove 67. In an embodiment, the retaining member 70 is fabricated from a metal, such as, for example, and not limitation stainless steel or spring steel; however, it is within the scope of the present invention to fabricate the retaining member 70 from other materials. Furthermore, in alternative embodiments, the retaining member 70 may be fabricated without the cutout 105. By way of example, and not limitation, the retaining member may be fabricated without the cutout 105 in embodiments wherein the retaining member 70 is assembled onto the rotatable coupling 50 via a heat shrink process or a snap fit process.

The present description depicts specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described above can be combined in various ways to form multiple variations of the invention. As a result, the invention is not limited to the specific examples described above, but only by the claims and their equivalents.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other couplings, and not just to the embodiments described above and shown in the accompanying figures. Accordingly, the scope of the invention should be determined from the following claims.

We claim:

1. A rotatable coupling (50), comprising:
a body (55) defining a cavity (51) that extends from a first end (56) of the body (55) to a second end (66) of the body (55);
the second end (66) of the body (55) includes an outer surface (68) that defines a retaining groove (67); and
a retaining member (70) that is rotatably mounted within the retaining groove (67) and provided with a plurality of raised flexible teeth (71).

2. The rotatable coupling (50) according to claim 1, wherein the retaining groove (67) is generally annular in shape.

3. The rotatable coupling (50) according to claim 1, wherein the retaining member (70) is generally annular in shape.

4. The rotatable coupling (50) according to claim 1, wherein the teeth (71) are located at an inner axial end (102) of the retaining member (70).

5. The rotatable coupling (50) according to claim 1, further comprising another groove (69) located on retaining member (70) outer surface (68) and an elastomeric seal (37) located within the another groove (69).

6. The rotatable coupling (50) according to claim 1, further comprising another groove (69) located on the retaining member (70) outer surface (68) and an elastomeric seal (37) located within the another groove (69), wherein the retaining groove (67) is located inward on the second end (66) relative to the another groove (69).

7. The rotatable coupling (50) according to claim 1, wherein the body (55) is provided with an elbow shape.

8. The rotatable coupling (50) according to claim 1, wherein the body (55) is fabricated as one-piece.

9. The rotatable coupling (50) according to claim 1, wherein the retaining member (70) is provided with a first radial end (103), a second radial end (104), and a cutout (105) located between the first and second radial ends (103, 104).

10. The rotatable coupling (50) according to claim 1, wherein the retaining member is provided with a portion (72), which lies substantially flush with the outer surface (68) on the second end (66) of the body (55).

11. A rotatable coupling (50), comprising:
a body (55) defining a cavity (51) that extends from a first end (56) of the body (55) to a second end (66) of the body (55);
the second end (66) of the body (55) includes an outer surface (68) that defines a retaining groove (67);
a retaining member (70), wherein the retaining member (70) is:
rotatably mounted within the retaining groove (67);
provided with a plurality of raised flexible teeth (71); and
provided with a first radial end, a second radial end, and a cutout space that is defined between the first and second radial ends and positioned within the retaining groove (67).

12. The rotatable coupling (50) according to claim 11, wherein the retaining groove (67) is generally annular in shape.

13. The rotatable coupling (50) according to claim 11, wherein the retaining member (70) is generally annular in shape.

14. The rotatable coupling (50) according to claim 11, wherein the teeth (71) are located at an inner axial end (102) of the retaining member (70).

15. The rotatable coupling (50) according to claim 11, further comprising another groove (69) located on retaining member (70) outer surface (68) and an elastomeric seal (37) located within the another groove (69).

16. The rotatable coupling (50) according to claim 11, further comprising another groove (69) located on the retaining member (70) outer surface (68) and an elastomeric seal (37) located within the another groove (69), wherein the retaining groove (67) is located inward on the second end (66) relative to the another groove (69).

17. The rotatable coupling (50) according to claim 11, wherein the body (55) is provided with an elbow shape.

18. The rotatable coupling (50) according to claim 11, wherein the body (55) is fabricated as one-piece.

19. The rotatable coupling (50) according to claim 1, wherein the retaining member (70) is provided with a first radial end (103), a second radial end (104), and a cutout (105) located between the first and second radial ends (103, 104).

20. The rotatable coupling (50) according to claim 1, wherein the retaining member is provided with a portion (72), which lies substantially flush with the outer surface (68) on the second end (66) of the body (55).
